(19) United States
(12) Patent Application Publication
(10) Pub. No.: US 2026/0317852 A1
(43) Pub. Date: Oct. 15, 2026

(54) ORE FILTRATION

(71) Applicant: COATEX, Genay (FR)

(72) Inventors: Mehdi BOUZID, Sainte Foy Les Lyon (FR); Jacques MONGOIN, Quincieux (FR)

(73) Assignee: COATEX, Genay (FR)

(21) Appl. No.: 19/482,889

(22) PCT Filed: Apr. 18, 2024
(86) PCT No.: PCT/FR2024/000052

§ 371 Date: Nov. 10, 2025

(30) Foreign Application Priority Data
May 12, 2023 (FR) FR2304733

(51) Int. Cl. C22B 3/22; C22B 3/44

(52) U.S. Cl. CPC C22B 3/22; C22B 3/44

(57) ABSTRACT

A method for concentrating an aqueous composition of metal ore concentrate, in particular by filtration may be is carried out by partial separation of the water from this composition in the presence of an aqueous concentration agent including at least one polymer prepared by radical polymerization of an unsaturated carboxylic acid. A filter cake from such a filtration may have a reduced moisture content and may be obtained by using this polymer during the concentration of the metal ore concentrate.

The invention relates to a method for concentrating an aqueous composition of metal ore concentrate, in particular by filtration. The concentration is carried out by partial separation of the water from this composition in the presence of an aqueous concentration agent comprising at least one polymer prepared by radical polymerisation of an unsaturated carboxylic acid. The invention also relates to the filter cake, which has a reduced moisture content and which is obtained using this polymer when concentrating the metal ore concentrate.

The method according to the invention is used in a mining process involving at least one mineral deposit. These mining methods generally make it possible to obtain at least one useable metal from a metal ore. Mining methods are usually implemented using water as a medium for processing or transporting the dry solids content. According to the invention, the fraction of the useable metal ore is a concentrate of one or of several metals. When using the concentration method according to the invention, an essential step is to add an aqueous concentration agent A comprising at least one polymer P to a metal ore concentrate. This step is therefore usually carried out in a mining method comprising various metal ore processing steps. Mining methods usually comprise several metal ore processing steps. A mining method conventionally comprises one or more of the following steps:
crushing the metal ore,
grinding the metal ore, in particular dry grinding or wet grinding, usually in water,
separating, in particular by flotation, the useable metal or a derivative of the useable metal from the metal ore residue,
purifying or enriching the useable metal or a derivative of the useable metal, in particular by flotation,
concentrating the metal ore concentrate or the metal ore residue, for example by filtration, by settling, by gravity, or using a thickener,
partially separating the aqueous metal ore residue and part of the water,
transporting the metal ore concentrate or the aqueous metal ore residue,
storing the metal ore concentrate, the aqueous metal ore residue.

To facilitate their handling, the aqueous suspensions usually have a lower solids content. In fact, adding water can help lower the viscosity or the flow threshold of these suspensions. However, adding water leads to problems with water and energy consumption.

Compatibility with the various constituents of aqueous mineral suspensions prepared from a mining derivative is also an important property to look for, in particular compatibility with a flocculating agent that can be used to process the metal ore, the metal ore concentrate or the aqueous metal ore residue, in particular compatibility with a polyacrylamide or a polyacrylamide derivative. Likewise, it is important to control the viscosity of aqueous mineral suspensions prepared from a mining derivative, in particular to make them easier to pump, stir or transport. Moreover, it is important to have methods that make it possible to control the flow threshold of the suspensions used.

Most importantly, reducing the consumption of water when processing mining derivatives should also be sought. Water recovery or recycling during the various steps in the mining methods is therefore essential. Both the amount of water that is separated or recycled and the quality of the separated or recycled water, particularly its limited turbidity, should be sought.

When concentrating a metal ore, improving the conditions of this concentration, in particular when separating the water from the metal ore, for example by filtration, should favourably influence the overall economic and energy balance. For example, controlling the viscosity or flow threshold of the medium can reduce the necessary filtration force. Improving the concentration yield should also make it possible to reduce the number of maintenance operations and the time required for such operations, particularly for filtration systems. Efforts must also be made to avoid slowdowns, loss of efficacy or blockages when using such equipment, for example if the filter becomes partially or completely clogged, in particular to reduce operating times, energy consumption, maintenance operations or the use of the various resources required. Effective control of the size of the metal ore particles to be concentrated must also be targeted.

Once concentrated after partial dewatering, the filter cake must have a low, well-controlled moisture content, particularly to enable it to be transported safely and effectively. Transport usually takes place in bulk and therefore requires a high degree of stability, particularly for transport by bulk carrier vessels. A low moisture content approaching saturation will limit water transfer during transport. The slightest reduction in moisture content can therefore improve transport conditions and safety, particularly during maritime transport. Poorly-controlled moisture content can alter the density of metal ore concentrate in a ship's hold, leading to unbalanced loading. Moreover, excessive moisture content in a metal ore concentrate can result in a hydrogen release or in overheating, leading to a risk of self-combustion.

Document GB 2098194 describes a method for dewatering an aqueous suspension of phosphate, coal, lignite, clays or cement ore.

Document FR 3082124 describes a method for controlling the settling of an aqueous composition so as to improve its uniformity but without dewatering it. The article by Chaedir Benitta et al (Advances in dewatering and drying in mineral processing, Drying Technology, 2021) relates to a study of the technologies available for dewatering or filtration in the mining process.

The method according to the invention provides a solution to all or part of the problems of the methods used in the prior art for concentrating an aqueous composition of metal ore concentrate. The invention therefore provides a method for concentrating an aqueous composition comprising at least one concentrate of at least one metal ore comprising the partial separation of water in the presence of an aqueous concentration agent A comprising at least one polymer P prepared by at least one radical polymerisation reaction, at a temperature greater than 50° C., of at least one anionic monomer M comprising at least one polymerisable olefinic unsaturation and at least one carboxylic acid group or of one of its salts, in the presence of at least one radical-generating compound chosen among hydrogen peroxide, benzoyl peroxide, acetyl peroxide, laurel peroxide, tert-butyl hydroperoxide, cumene hydroperoxide, ammonium persulphate, an alkaline metal persulphate, an azo compound, such as 2,2′-azobis(2-(4,5-dihydroimidazolyl)propane, 2,2′-azobis(2-methylpropionamidine) dihydrochloride, diazo-valeronitrile, 4,4′-azobis-(4-cyanovaleric) acid, AZDN or 2,2′-azobisisobutyronitrile, and their respective combinations or associations with an ion chosen among Fe^{II}, Fe^{III}, Cu^{I}, Cu^{II} and mixtures thereof.

Preferably for the method according to the invention, the partial separation of the water is carried out by centrifugation or by filtration, in particular by fabric or membrane filtration, for example using a ceramic membrane. More preferably, separation is carried out by filtration using a device chosen among a filtration press, a filter press, a rotary filter, a drum filter, a vacuum or suction filter and combinations thereof. The use of a filtration press or a filter press is particularly preferred.

Preferably according to the invention, the membrane used has a permeability greater than 10 L/(dm²·min) at 200 Pa or a permeability less than 150 L/(dm²·min) at 200 Pa. More preferably according to the invention, the membrane used has a permeability ranging from 20 L/(dm²·min) to 120 L/(dm²·min) at 200 Pa or ranging from 50 L/(dm²·min) to 100 L/(dm²·min) at 200 Pa.

The conditions for using the concentration method according to the invention can vary, in particular the duration or the flow rate of the separation step. Preferably for the method according to the invention, the separation time, measured according to the method in the examples, is less than 20 minutes. More preferably, it is less than 10 minutes or less than 5 minutes. According to the invention, the separation time is advantageously greater than 30 seconds or greater than 1 minute. According to the invention, the separation time is the effective time of the active step in which the water is separated from the metal ore concentrate. Also preferably according to the invention, the flow rate at which the metal ore concentrate is separated from the water, measured relative to the separation surface and to the amount of metal ore, measured according to the method in the examples, is greater than 950 kg/(m²·h). More preferably, the separation flow rate is greater than 1,200 kg/(m²·h) or greater than 1,300 kg/(m²·h). Much more preferably, the separation flow rate is greater than 1,400 kg/(m²·h).

According to the invention, the separation flow rate measures, as a function of time, the amount by mass of metal ore concentrate that is separated relative to the separation surface, in particular the filtration surface. According to the invention, the separation flow rate measures the concentration flow rate or the filtration flow rate.

The concentration method according to the invention is used with an aqueous composition comprising at least one metal ore concentrate, in particular an aqueous composition of metal ore concentrate obtained after separating the ore from the gangue, usually by flotation or by flotation and settling.

Preferably according to the invention, the aqueous composition to be concentrated has a concentration in dry solids content, preferably of metal ore concentrate, measured by loss on drying, greater than 10% by weight or greater than 15% by weight. More preferably, it has a concentration in dry solids greater than 20% by weight.

Also preferably according to the invention, the aqueous composition to be concentrated has a concentration in dry solids content, preferably of metal ore concentrate, measured by loss on drying, of less than 45% by weight or less than 35% by weight or less than 30% by weight. More preferably, it has a concentration in dry solids content of less than 35% by weight or less than 30% by weight.

Also preferably, the aqueous composition to be concentrated has a concentration in dry solids content, preferably of metal ore concentrate, measured by loss on drying, ranging from 10 to 45% by weight or from 10 to 40% by weight or from 10 to 35% by weight or from 10 to 30% by weight.

Also preferably, the aqueous composition to be concentrated has a concentration in dry solids content, preferably of metal ore concentrate, measured by loss on drying, ranging from 15 to 45% by weight or from 15 to 40% by weight or from 15 to 35% by weight or from 15 to 30% by weight.

More preferably, the aqueous composition to be concentrated has a concentration in dry solids content, preferably of metal ore concentrate, measured by loss on drying, ranging from 20 to 45% by weight or from 20 to 40% by weight or from 20 to 35% by weight or from 20 to 30% by weight.

The method according to the invention uses an aqueous composition to be concentrated that has a viscosity or a flow threshold that are particularly advantageous. Preferably according to the invention, the aqueous composition to be concentrated has a Brookfield viscosity, measured at 100 rpm and at 25° C., of less than 1,800 mPa·s, preferably less than 1,500 mPa·s or less than 1,200 mPa·s. More preferentially, the viscosity is less than 1,000 mPa·s or less than 900 mPa·s. Much more preferentially, the viscosity of the aqueous composition to be concentrated is less than 800 mPa·s or less than 700 mPa·s or even less than 500 mPa·s.

Also preferably according to the invention, the aqueous composition to be concentrated has a flow threshold measured at a temperature of 25° C. using a rheometer with imposed shearing, equipped with a bladed spindle, for a particular torsional loading, of less than 20 Pa or less than 10 Pa.

More preferably, the flow threshold is greater than 1.0 Pa. More preferably, the flow threshold is greater than 1.2 Pa, more preferentially greater than 1.5 Pa.

According to the invention, the flow threshold, which characterises the flow resistance, is measured on a sample of aqueous composition of metal ore concentrate. The flow threshold is the shearing that must be applied to a composition to cause it to flow. If the shearing is insufficient, the composition deforms elastically whereas if the shearing is sufficient, the composition can flow like a liquid.

According to the invention, the flow threshold expressed in Pascals (Pa) is measured at a temperature of 25° C. using a Brookfield DV3T rheometer with imposed shearing, equipped with a suitable spindle with blades. Without destroying the underlying structure, the bladed spindle is immersed into the composition up to the first immersion mark. After a one-minute wait time, the measure is taken without pre-shearing at a speed of 0.5 rpm. This relatively low speed is preferred so as to minimise the inertia effect of the bladed spindle. The variation in torsional loading measured by the instrument in order to maintain a spin speed of 0.5 rpm is tracked over time. The value of the flow limit or flow threshold of the composition is indicated by the instrument when this variation is zero.

Preferably, the metal ore is chosen among a lithium, strontium, lanthanide, actinide, uranium, rare earth, titanium, zirconium, vanadium, niobium, chromium, molybdenum, tungsten, manganese, iron, cobalt, rhodium, iridium, nickel, palladium, platinum, copper, silver, gold, zinc, cadmium, tin, lead ore. Particularly preferably, the metal ore is chosen among a copper ore, a molybdenum ore, a nickel ore, in particular a copper ore.

According to the invention, the metal ore can comprise a metal oxide, a metal sulphide or a metal carbonate.

When using the concentration method according to the invention, the metal ore concentrate is in the form of particles, preferably in the form of particles, measured by laser diffraction, that have a D90 diameter of less than 150 μm, preferably a D90 diameter of less than 100 μm.

Preferably according to the invention, the metal ore concentrate particles have a D80 diameter of less than 90 μm, preferably a D80 diameter of less than 80 μm or less than 70 μm or less than 60 μm.

Generally according to the invention, the metal ore concentrate particles have a D10 diameter greater than 1 μm, preferably a D80 diameter greater than 2 μm or greater than 5 μm or greater than 10 μm.

The concentration method according to the invention makes it possible to effectively separate some of the water from the aqueous composition of metal ore concentrate to be concentrated.

Essentially, the concentration method according to the invention uses an aqueous concentration agent A comprising at least one polymer P prepared by at least one radical polymerisation reaction of at least one anionic monomer M comprising at least one polymerisable olefinic unsaturation and at least one carboxylic acid group or of one of its salts.

Preferably for the method according to the invention, polymer P is used in an amount by dry weight ranging from 20 ppm to 500 ppm, preferably from 30 ppm to 300 ppm or from 40 ppm to 200 ppm, more preferentially from 50 ppm to 150 ppm, relative to the amount of metal ore concentrate or of dry solids content of the composition to be concentrated.

Also preferably according to the invention, polymer P has an average molecular mass Mw, measured by SEC, ranging from 2,000 g/mol to 20,000 g/mol. More preferably, it ranges from 2,200 g/mol to 10,000 g/mol or from 2,400 g/mol to 9,500 g/mol or from 2,400 g/mol to 8,000 g/mol. Much more preferentially, it ranges from 2,400 g/mol to 6,500 g/mol.

According to the invention, the molecular mass Mw is determined by Size Exclusion Chromatography (SEC) or Gel Permeation Chromatography (GPC). This technique uses a “Waters” liquid chromatography instrument equipped with a detector. This detector is a “Waters” refractive index detector. This liquid chromatography instrument is equipped with a size exclusion column in order to separate the various molecular weights of the copolymers studied. The liquid elution phase is an aqueous phase adjusted to pH 9.00 using 1N sodium hydroxide containing 0.05 M of NaHCO₃, 0.1 M of NaNO₃, 0.02 M of triethanolamine and 0.03% of NaN₃.

According to a first step, the copolymer solution is diluted to 0.9% by dry weight in the dissolution solvent of the SEC, which corresponds to the liquid elution phase of the SEC to which 0.04% of dimethyl formamide, which acts as a flow marker or internal standard, is added. Then, it is filtered using a 0.2 μm filter. Then, 100 μL are injected into the chromatograph (eluent: an aqueous phase adjusted to pH 9.00 by 1N sodium hydroxide containing 0.05 M of NaHCO₃, 0.1 M of NaNO₃, 0.02 M of triethanolamine and 0.03% of NaN₃).

The liquid chromatography instrument has an isocratic pump (“Waters” 515), the flow rate of which is set to 0.8 mL/min. The chromatography instrument also comprises an oven, which itself comprises the following system of columns in series: a “Waters Ultrahydrogel Guard” precolumn measuring 6 cm in length and 40 mm in inner diameter and a “Waters Ultrahydrogel” linear column measuring 30 cm in length and 7.8 mm in inner diameter. The detection system consists of a “Waters RI” 410 refractometric detector. The oven is heated to 60° C. and the refractometer is heated to 45° C. The chromatography instrument is calibrated using sodium polyacrylate powder standards with different molecular masses certified by the supplier: Polymer Standards Service or American Polymers Standards Corporation (molecular mass ranging from 900 to 2,250,000 g/mol and polymolecularity index ranging from 1.4 to 1.7).

According to the invention, polymer P is prepared by a radical polymerisation reaction that uses at least one radical-generating compound. Preferably, the radical-generating compound is chosen among hydrogen peroxide, sodium persulphate, potassium persulphate and their respective combinations or associations with an ion chosen among Fe^{II}, Fe^{III}, Cu^{I}, Cu^{II} and combinations thereof.

In addition to monomer M and the radical-generating compound, the polymerisation reaction can also be carried out in the presence of at least one compound comprising phosphorus in the oxidation I state, preferably a compound chosen among hypophosphorous acid (H₃PO₂) and a derivative of hypophosphorous acid (H₃PO₂), preferably a compound comprising at least one hypophosphite ion (H₂PO₂), more preferentially a compound chosen among sodium hypophosphite (H₂PO₂Na), potassium hypophosphite (H₂PO₂K), calcium hypophosphite ([H₂PO₂]₂Ca) and mixtures thereof.

The polymerisation reaction can also be carried out in the presence of at least one compound comprising phosphorus in the oxidation III state, preferably a compound chosen among phosphorous acid and a derivative of phosphorous acid, more preferentially a compound comprising at least one phosphite ion, in particular a compound chosen among sodium phosphite, calcium phosphite, potassium phosphite, ammonium phosphite, and combinations thereof. It can also be carried out in the presence of at least one compound comprising a bisulphite ion, preferably a compound chosen among ammonium bisulphite, an alkaline metal bisulphite, in particular sodium bisulphite, potassium bisulphite, calcium bisulphite, magnesium bisulphite, and combinations thereof.

According to the invention, the polymerisation reaction can also be carried out in the presence of from 0.05 to 5% by weight, relative to the total amount of monomers, of at least one compound chosen among a xanthate derivative, a mercaptan compound and a compound of formula (I):

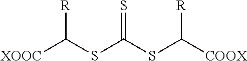

wherein:
X independently represents H, Na or K,
R independently represents a C₁-C₅-alkyl group, preferably a methyl group; particularly a compound of formula (I) which is disodic diisopropionate trithiocarbonate (DPTTC).

The polymerisation reaction is carried out at a temperature greater than 50° C. Preferably, the polymerisation reaction is carried out at a temperature ranging from 50° C. to 98° C., preferably from 50° C. to 95° C. or from 50° C. to 85° C. A higher temperature, in particular above 100° C., may be used by adjusting the pressure of the reaction medium to prevent evaporation.

According to the invention, the polymerisation reaction is preferentially carried out in water, in a solvent, alone or in a mixture with water, particularly an alcoholic solvent, in particular isopropyl alcohol. Water is preferred.

According to the invention, polymer P can be completely or partially neutralised, particularly at the end of the polymerisation reaction. Preferably according to the invention, the neutralisation of polymer P is carried out by neutralising or salifying all or part of the carboxylic acid groups present in the polymer. Preferably, this neutralisation is carried out using a base, for example using a derivative of an alkaline metal or a derivative of an alkaline-earth metal. The preferred bases are chosen among ZnO, MgO, LiOH, NaOH, KOH, NH₄OH, Ca(OH)₂, Mg(OH)₂, monoisopropylamine, triethanolamine, triisopropylamine, 2-amino-2-methyl-1-propanol (AMP), triethylamine, diethylamine, monoethylamine. Particularly preferably, neutralisation is carried out using ZnO, MgO, LiOH, NaOH, Ca(OH)₂, Mg(OH)₂, alone or in combination.

Preferably according to the invention, the polymerisation reaction uses:
100% by weight of anionic monomer M or
from 70% to 99.5% by weight of anionic monomer M and from 0.5% to 30% by weight of at least one other monomer.

Preferably for the method according to the invention, the anionic monomer M comprising at least one polymerisable olefinic unsaturation, comprises one or two carboxylic acid groups, preferably comprises a single carboxylic acid group. More preferentially, it is chosen among acrylic acid, methacrylic acid, an acrylic acid salt, a methacrylic acid salt and mixtures thereof, much more preferentially acrylic acid.

According to the invention, the polymerisation reaction can also use at least one other monomer, preferably another monomer chosen among:
another anionic monomer, preferably a monomer chosen among acrylic acid, methacrylic acid, itaconic acid, maleic acid, maleic anhydride and mixtures thereof;
2-acrylamido-2-methylpropanesulphonic acid, a 2-acrylamido-2-methylpropanesulphonic acid salt, 2-(methacryloyloxy)ethanesulphonic acid, a 2-(methacryloyloxy)ethanesulphonic acid salt, sodium methallyl sulphonate, styrene sulphonate and combinations or mixtures thereof;
a non-ionic monomer comprising at least one polymerisable olefinic unsaturation, preferably at least one polymerisable ethylenic unsaturation and in particular a polymerisable vinyl group, more preferentially a non-ionic monomer chosen among styrene, vinyl caprolactam, the esters of an acid comprising at least one monocarboxylic acid group, in particular an ester of an acid chosen among acrylic acid, methacrylic acid and mixtures thereof, for example hydroxyethyl acrylate, hydroxypropyl acrylate, hydroxyethyl methacrylate, hydroxypropyl methacrylate, alkyl acrylate, in particular C₁-C₁₀-alkyl acrylate, preferentially C₁-C₄-alkyl acrylate, more preferentially acrylate, methyl ethyl acrylate, n-propyl acrylate, isopropyl acrylate, isobutyl acrylate, n-butyl acrylate, alkyl methacrylate, in particular C₁-C₁₀-alkyl methacrylate, preferentially C₁-C₄-alkyl methacrylate, more preferentially methyl methacrylate, ethyl methacrylate, n-propyl methacrylate, isopropyl methacrylate, isobutyl methacrylate, n-butyl methacrylate, aryl acrylate, preferably phenyl acrylate, benzyl acrylate, phenoxyethyl acrylate, aryl methacrylate, preferably phenyl methacrylate, benzyl methacrylate, phenoxyethyl methacrylate;
a monomer of formula (II):

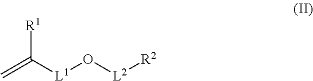

wherein:
R¹ and R², identical or different, independently represent H or CH₃,
L¹ independently represents a group chosen among C(O), CH₂, CH₂—CH₂ and O—CH₂—CH₂—CH₂—CH₂,
L² independently represents a group chosen among (CH₂—CH₂O)ₓ, (CH₂CH(CH₃)O)_{y}, (CH(CH₃)CH₂O)_{z} and combinations thereof and
x, y and z, identical or different, independently represent an integer or decimal comprised between 0 and 150 and the sum of x+y+z is comprised between 10 and 150.

Preferably according to the invention, polymer P is not cross-linked.

Advantageously according to the invention, polymer P can be a non-sulphonated polymer, in particular a polymer prepared in the absence of 2-acrylamido-2-methylpropanesulphonic acid or of 2-acrylamido-2-methylpropanesulphonic acid salt.

The method according to the invention can comprise the addition of one, two or three different polymer(s) P or of at least one additional compound chosen among a lignosulphonate derivative, a silicate, an unmodified polysaccharide and a modified polysaccharide.

Essentially according to the invention, the aqueous concentration agent A comprises at least one polymer P. It can also comprise other ingredients. When using another ingredient in agent A according to the invention, it is preferentially chosen among at least one derivative S chosen among an ose S1 comprising from 3 to 8 carbon atoms, an ose oligomer S2 comprising from 1 to 10 ose units and a product S3 resulting from the degradation of a saccharide.

More preferably according to the invention, ose S1 is chosen among trioses (oses comprising 3 carbon atoms), tetroses (oses comprising 4 carbon atoms), pentoses (oses comprising 5 carbon atoms), hexoses and deoxyhexoses (oses comprising 6 carbon atoms), heptoses (oses comprising 7 carbon atoms), octoses (oses comprising 8 carbon atoms); preferably chosen among glyceraldehyde, dihydroxyacetone, erythrose, threose, erythrulose, deoxyribose, ribose, arabinose, xylose, lyxose, ribulose, xylulose, allose, altrose, galactose, glucose, gulose, idose, mannose, talose, fructose, psicose, sorbose, tagatose, fucose, rhamnose, sedoheptulose, mannoheptulose, heptahydroxyoctanal.

Also preferably according to the invention, oligomer (S2) is chosen among ose dimers, ose trimers; preferably chosen among dextrose, maltose, lactose, sucrose, maltoriose, maltotetraose, alpha-glucoheptonic acid, beta-glucoheptonic acid.

Also preferably according to the invention, product (S3) is chosen among aldoses, synthetic monosaccharide derivatives, synthetic disaccharide derivatives; preferably chosen among sorbitol, mannitol, gluconic acid, citric acid, isocitric acid, lactic acid, tartaric acid, salts of these acids.

More preferably according to the invention, derivative S is chosen among sorbitol, mannitol, gluconic acid, citric acid, isocitric acid, lactic acid, tartaric acid, salts of these acids, dextrose, maltose, glucose, a mixture of glucose and of maltose, lactose, sucrose, maltoriose, maltotetraose, alpha-glucoheptonic acid, beta-glucoheptonic acid, salts of these acids and combinations of these derivatives.

Also more preferably for agent A according to the invention, the S/P ratio of the amounts by dry weight of derivative S and of polymer P ranges from 0.1 to 10 or from 0.2 to 5 or from 0.3 to 5, preferably from 0.5 to 4 or from 0.5 to 3.

Preferably according to the invention, the concentration method uses no surfactant compound, preferably no surfactant ester, in particular polyethylene glycol and lauric acid ester, malic acid octanoate, polyethylene glycol fatty acid ester, polyethylene glycol and myristic acid ester, hexamethylene glycol monooleate.

In addition to the concentration method, the invention also provides a method for improving the filtration of an aqueous composition that comprises at least one metal ore concentrate. The method for improving the filtration of an aqueous composition according to the invention comprises using at least one concentration method defined according to the invention.

The invention also provides a concentrated aqueous composition comprising at least one metal ore concentrate and an aqueous concentration agent A comprising at least one polymer P that is prepared by at least one radical polymerisation reaction, at a temperature greater than 50° C., of at least one anionic monomer M comprising at least one polymerisable olefinic unsaturation and at least one carboxylic acid group or of one of its salts, in the presence of at least one radical-generating compound chosen among hydrogen peroxide, benzoyl peroxide, acetyl peroxide, laurel peroxide, tert-butyl hydroperoxide, cumene hydroperoxide, ammonium persulphate, an alkaline metal persulphate, an azo compound, such as 2,2′-azobis(2-(4,5-dihydroimidazolyl)propane, 2,2′-azobis(2-methylpropionamidine) dihydrochloride, diazo-valeronitrile, 4,4′-azobis-(4-cyanovaleric) acid, AZDN or 2,2′-azobisisobutyronitrile, and their respective combinations or associations with an ion chosen among Fe^{II}, Fe^{III}, Cu^{I}, Cu^{II} and mixtures thereof or a concentrated aqueous composition prepared according to the concentration method according to the invention. Preferably according to the invention, the concentrated aqueous composition according to the invention comprises a moisture content of less than 15% by weight, more preferentially less than 14% by weight or less than 13% by weight, much more preferentially less than 12% by weight or less than 11% by weight, measured by loss on drying.

The invention also provides an aqueous filter cake comprising at least one metal ore concentrate and an aqueous concentration agent A comprising at least one polymer P that is prepared by at least one radical polymerisation reaction, at a temperature greater than 50° C., of at least one anionic monomer M comprising at least one polymerisable olefinic unsaturation and at least one carboxylic acid group or of one of its salts, in the presence of at least one radical-generating compound chosen among hydrogen peroxide, benzoyl peroxide, acetyl peroxide, laurel peroxide, tert-butyl hydroperoxide, cumene hydroperoxide, ammonium persulphate, an alkaline metal persulphate, an azo compound, such as 2,2′-azobis(2-(4,5-dihydroimidazolyl)propane, 2,2′-azobis(2-methylpropionamidine) dihydrochloride, diazo-valeronitrile, 4,4′-azobis-(4-cyanovaleric) acid, AZDN or 2,2′-azobisisobutyronitrile, and their respective combinations or associations with an ion chosen among Fe^{II}, Fe^{III}, Cu^{I}, Cu^{II} and mixtures thereof or aqueous filter cake prepared according to the concentration method according to the invention. Preferably, the filter cake according to the invention comprises a moisture content of less than 15% by weight, more preferentially less than 14% by weight or less than 13% by weight, much more preferentially less than 12% by weight or less than 11% by weight, measured by loss on drying.

The particular, advantageous or preferred characteristics of the concentration method according to the invention define filtration improvement methods, concentrated aqueous compositions and aqueous filter cakes which are also particular, advantageous or preferred. The following examples illustrate the various aspects of the invention.

### EXAMPLES

### Preparation of Aqueous Concentration Agents According to the Invention

### Aqueous Agent A1

209.7 g of water, 0.08 g of iron sulphate heptahydrate and 0.011 g of copper sulphate pentahydrate are weighed into a 1 L reactor equipped with mechanical stirring, oil-bath heating and peristaltic pumps. The mixture is then heated to 95° C. and, using the peristaltic pumps, 302.5 g of acrylic acid and 13 g of water, 25.6 g of sodium hypophosphite monohydrate dissolved in 29 g of water, 20.46 g of hydrogen peroxide 130V diluted with 25 g of water are added in 120 minutes. The mixture is then heated for 60 minutes at 95° C., after which it is cooled, neutralised with 50% sodium hydroxide in water to pH 8.5 and diluted to obtain a 40% dry solids content. This results in aqueous agent A1 comprising the sodium polyacrylate polymer P1, with Mw 4,400 g/mol.

### Aqueous Agent A2

142.9 g of an aqueous concentration agent prepared using the method used to prepare aqueous agent A1 are weighed into a beaker, then, under stirring at 1,000 rpm with a “VMI” turbine 30 motor, 50 g of an S1 derivative (glucose syrup at 80% solids content by weight, “Cargill” CSweet M01658) and 45 g of water are added. This results in aqueous concentration agent A2 comprising polymer P1 and derivative S1 at a mass ratio of 60/40.

### Assessment of Concentration Methods for Aqueous Copper Ore Concentrate Compositions According to the Invention

An aqueous composition comprising a copper ore concentrate is collected from the output of a thickener at a copper mine in Chile after crushing, grinding, flotation of the ore and separation of the copper concentrate from the gangue, then thickening the copper concentrate. This initial composition is stirred to make it uniform and then characterised to assess its properties:
specific density by the pycnometer method using a pycnometer,
particle size distribution by the laser diffraction method using a diffractometer (“Malvern Mastersizer” 3000),
concentration (% by weight) of copper concentrate by the X-ray diffraction method by using a “Bruker” D2-Phaser diffractometer,
viscosity (mPa·s) by Brookfield measurement (rotary modulus) and flow threshold by “Haake” measurement (Vane cut) using a “Haake” Viscotester 550 viscometer,
mass solids content by loss on drying using an oven heated for 1 hour at 120° C.

The results are shown in Table 1.

TABLE 1

| | |
|---|---|
| Specific density | 4.6 |
| D10 - μm | 3 |
| D50 - μm | 20 |
| D80 - μm | 54 |
| D90 - μm | 89 |
| Cu content - % by weight | 30.24 |
| Fe content - % by weight | 19.91 |
| Si content - % by weight | 4.91 |
| As content - % by weight | 0.711 |
| Viscosity - mPa · s | 4.182 |
| Flow threshold - Pa | 1.82 |

The concentration method is applied by filtering the aqueous composition comprising the copper ore concentrate; this is carried out using:
a metal beaker equipped with a piston pump capable of feeding the saturation chamber,
a saturation chamber (38 mm thick) comprising a filter (“Roxia” W-TA 301) made of polypropylene fabric with a diameter of 0.078 m, a surface area of 0.0048 m², a thickness of 1.8 mm, a density of 1,100 g/m² and a permeability of 70 L/(dm²·min) at 200 Pa.

The aqueous composition comprising the copper ore concentrate (65% by weight) and, optionally, aqueous concentration agent A1 or A2 according to the invention, are introduced into the beaker in different amounts (expressed as ppm by weight of dry solids content of agent A1 or A2 relative to the amount of dry solids content of the copper concentrate), then the composition, optionally comprising the aqueous concentration agent, is pumped into the saturation chamber. Pressure (65+/−3 kPa) is applied for a time t to filter the concentrate by separating the water using the filter. The filter cake is then removed from the saturation chamber and the filter is blown dry for 2 minutes (65+/−3 kPa). After filtration, the moisture content (% by weight), the thickness of the filter cake (mm) and the flow rate (kg/(m²×h)) are measured.

The results are shown in Table 2.

TABLE 2

| | | | Moisture | Filter cake | |
|---|---|---|---|---|---|
| Example | Time t | Agent A | content | thickness | Flow rate |
| 1 | 2 | / | 12.3 | 37.4 | 1,357 |
| 2 | 2 | A1 | 11.7 | 37.3 | 1,409 |
| | | 50 | | | |
| 3 | 2 | A2 | 11.3 | 37.4 | 1,422 |
| | | 50 | | | |
| 4 | 2 | A1 | 10.9 | 37.2 | 1,367 |
| | | 100 | | | |
| 5 | 2 | A2 | 10.4 | 37.0 | 1,415 |
| | | 100 | | | |
| 5 | 4 | / | 11.4 | 37.4 | 919 |
| 6 | 4 | A1 | 10.7 | 37.4 | 956 |
| | | 100 | | | |
| 7 | 4 | A2 | 10.6 | 37.0 | 958 |
| | | 100 | | | |
| 8 | 7 | / | 11.2 | 37.3 | 626 |

1. A method for concentrating an aqueous composition comprising at least one concentrate of at least one metal ore, the method comprising:
partially separating water in the presence of an aqueous concentration agent A from the aqueous composition,
wherein the aqueous concentration agent A comprises a polymer P prepared by a process comprising radically polymerizing, at a temperature greater than 50° C., starting materials comprising an anionic monomer M comprising a polymerizable olefinic unsaturation and a carboxylic acid group, optionally in salt form, and a radical-generator comprising hydrogen peroxide, benzoyl peroxide, acetyl peroxide, laurel peroxide, tert-butyl hydroperoxide, cumene hydroperoxide, ammonium persulfate, an alkaline metal persulfate, and/or an azo compound, optionally as an association comprising Fe^{II}, Fe^{III}, Cu^{I}, and/or Cu^{II} ions.

2. The method of claim 1, wherein the partially separating comprises centrifugation or filtration.

3. The method of claim 1, wherein a separation time is less than 20 minutes, or greater than 30 seconds.

4. The method of claim 1, wherein the aqueous composition to be concentrated has a concentration in dry solids content, measured by loss on drying:
greater than 10% by weight; and/or
less than 45% by weight.

5. The method of claim 1, wherein the aqueous concentration agent A comprises an ose S1 comprising from 3 to 8 carbon atoms, an ose oligomer S2 comprising from 1 to 10 ose units, and/or a product S3 derived from the degradation of a saccharide.

6. The method of claim 1, wherein:
the polymer P is used in an amount by dry weight in a range of from 20 ppm to 500 ppm, relative to a metal ore concentrate amount; or
the polymer P has an average molecular mass Mw, measured by SEC, in a range of from 2,000 g/mol to 20,000 g/mol; or
the radically polymerizing is also carried out in an environment comprising a phosphorous (I) compound, comprising phosphorus in oxidation state I; or
the radically polymerizing is also carried out in an environment comprising a phosphorous (II) compound, comprising phosphorus in oxidation state III; or
the radically polymerizing is also carried out in an environment comprising a sulfurous compound comprising a bisulfite ion; or
the radically polymerizing is also carried out an environment comprising, in a range of from 0.05 to 5% by weight, relative to total monomers weight, a xanthate derivative, a mercaptan compound, and/or a compound of formula (I): 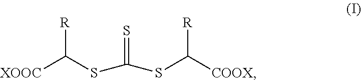
wherein
X is independently H, Na, or K,
R is independently C₁-C₅-alkyl group; or
the polymer P is at least partially neutralized; or
the starting materials comprise, as monomers of the anionic monomer M in at least 70 wt. %, and, optionally, a further monomer in a range of from 0.5 to 30 wt. %.

7. The method of claim 1, wherein the anionic monomer M comprises a single carboxylic acid group.

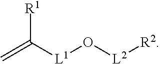

8. The method of claim 1, comprising:
adding one, two, or three different species of the polymer P.

9. A method for improving the filtration of an aqueous composition that comprises at least one metal ore concentrate, the method comprising:
implementing the method of claim 1.

10. A concentrated aqueous composition, comprising:
a metal ore concentrate; and
an aqueous concentration agent A comprising a polymer P,
wherein the a polymer P comprises, in radically polymerized form, polymerized at a temperature greater than 50° C., an anionic monomer M comprising a polymerizable olefinic unsaturation and a carboxylic acid group, optionally in salt form and a radical-generator comprising hydrogen peroxide, benzoyl peroxide, acetyl peroxide, laurel peroxide, tert-butyl hydroperoxide, cumene hydroperoxide, ammonium persulfate, an alkaline metal persulfate, and/or an azo compound optionally as a combination comprising a Fe^{II}, Fe^{III}, Cu^{I}, and/or Cu^{II} ion.

11. An aqueous filtration cake, comprising:
a metal ore concentrate; and
an aqueous concentration agent A comprising a polymer P,
wherein the a polymer P comprises, in radically polymerized form, polymerized at a temperature greater than 50° C., an anionic monomer M comprising a polymerizable olefinic unsaturation and a carboxylic acid group, optionally in salt form and a radical-generator comprising hydrogen peroxide, benzoyl peroxide, acetyl peroxide, laurel peroxide, tert-butyl hydroperoxide, cumene hydroperoxide, ammonium persulfate, an alkaline metal persulfate, and/or an azo compound optionally as a combination comprising a Fe^{II}, Fe^{III}, Cu^{I}, and/or Cu^{II} ion.

12. The method of claim 1, wherein the partially separating comprises fabric or membrane filtration.

13. The method of claim 1, wherein the partially separating comprises filtration using a filtration press, a filter press, a rotary filter or a drum filter, a vacuum filter, and/or suction filter.

14. The method of claim 1, wherein a separation flow rate of the metal ore concentrate and of water, measured relative to a separation surface and an amount of metal ore, is greater than 950 kg/(m²·h).

15. The method of claim 1, wherein the aqueous composition to be concentrated has:
a Brookfield viscosity, measured at 100 rpm and at 25° C., of less than 1,800 mPa·s; or
a flow threshold measured at a temperature of 25° C. using a rheometer with imposed shearing, equipped with a bladed spindle, for a particular torsional loading, of less than 20 Pa; or
a flow threshold greater than 1.0 Pa.

16. The method of claim 1, wherein the metal ore is lithium, strontium, lanthanide, actinide, uranium, rare earth, titanium, zirconium, vanadium, niobium, chromium, molybdenum, tungsten, manganese, iron, cobalt, rhodium, iridium, nickel, palladium, platinum, copper, silver, gold, zinc, cadmium, tin, or lead ore.

17. The method of claim 1, wherein the metal ore comprises a metal oxide, a metal sulfide, or a metal carbonate.

18. The method of claim 1, wherein the metal ore concentrate is in particulate form.

19. The method of claim 1, wherein the metal ore concentrate, measured by laser diffraction, having a D90 diameter of less than 150 μm.
